(19) United States
(12) Patent Application Publication
(10) Pub. No.: US 2019/0289152 A1
(43) Pub. Date: Sep. 19, 2019

(54) IMAGE PROCESSING APPARATUS AND PROGRAM

(71) Applicant: KONICA MINOLTA, INC., Tokyo (JP)

(72) Inventor: Yasushi Tsue, Tokyo (JP)

(73) Assignee: KONICA MINOLTA, INC., Tokyo (JP)

(21) Appl. No.: 16/281,178

(22) Filed: Feb. 21, 2019

(30) Foreign Application Priority Data
Mar. 15, 2018 (JP) 2018-048304

(51) Int. Cl. H04N 1/00; H04N 1/409

(52) U.S. Cl. CPC H04N 1/00803; H04N 1/00037; H04N 1/409; H04N 1/00013

(57) ABSTRACT

An image processing apparatus includes a hardware processor that acquires a read image obtained by reading an image printed on a recording medium based on a printing image by an image reader, wherein the hardware processor generates a difference image based on a difference between the read image and the printing image, and determines presence or absence of a defect in the read image based on magnitude of fluctuation of a pixel value in the difference image.

The entire disclosure of Japanese patent Application No. 2018-048304, filed on Mar. 15, 2018, is incorporated herein by reference in its entirety.

### BACKGROUND

### Technological Field

The present invention relates to an image processing apparatus and a program that compare a read image obtained by reading an image on a recording medium with a printing image to determine the presence or absence of a defect in a printed matter.

### Description of the Related Art

In the field of an image forming apparatus for printing an image on a sheet, there is a known technology that compares a read image acquired by reading a sheet on which an image is printed with a master image generated by reading a printed matter and, based on a comparison result, determines whether there is a defect in the printed matter.

Meanwhile, a plateless printing apparatus of an electrophotographic scheme or the like, which has become widespread in recent years, is good at printing a few copies and, in many cases, page printing content is different every time as invariable printing or the like.

In a case where the page printing content is different every time, in the technique of reading a printed matter and generating the master image to utilize as an object to be compared, it is necessary to perform printing and reading for generating the master image every time printing is performed, which is inefficient. In order to deal with this problem, it is known to generate the master image from print data such as a raster image processor (RIP) image.

However, in the image of a printed matter output after an image is formed on a sheet surface, inconsistency is produced in gloss unevenness, color, density, and the like depending on the type of sheet (recycled paper, plain paper, coated paper, and the like) to be output after an image is formed thereon. Therefore, when the read image of the printed matter is compared with the master image generated from the print data, there is a case where the difference between the two images becomes large due to the influence of gloss unevenness, color, density, and the like in the read image. In this case, a product checking apparatus sometimes erroneously identifies that a defect has happened even though the printed matter is normally printed.

Thus, there has been proposed a method of setting inspection conditions such as items to be inspected and inspection levels indicating strictness of inspection depending on the type of sheet (JP 2007-148027 A).

In addition, a method of correcting a threshold value serving as a criterion for pass/fail determination according to image forming conditions of an image forming apparatus has also been proposed (JP 2016-180856 A). For example, the density value of the read image is corrected depending on the variety of the number of lines of the screen, the writing resolution, and the reading resolution.

However, when the read image is compared with the RIP image, an error in the images is caused due to the variety of the characteristics (color reproduction, positional shift, flare, and the like) between the two images; as a consequence, a defect is erroneously identified in some cases although the actual printed matter is not defective.

In the method of JP 2007-148027 A, parameters are modified by sheet type, but only with these modifications, it is difficult to deal with errors due to color reproduction and positional shift caused by the state of the machine, an error such as flare, or the like; accordingly, there is a possibility that erroneous identification happens in inspection.

In addition, according to the method of JP 2016-180856 A, when interference occurs in the screen, the density largely fluctuates; in such a case, if the density of the read image is corrected in one direction, the absolute value of the error becomes larger and an abnormality is more likely to be erroneously identified.

### SUMMARY

The present invention has been made in view of the above circumstances and an object of the present invention is to provide an image processing apparatus and a program capable of suppressing erroneous identification of a defect when identifying a defect by comparing a read image and a printing image.

To achieve the abovementioned object, according to an aspect of the present invention, an image processing apparatus reflecting one aspect of the present invention comprises a hardware processor that acquires a read image obtained by reading an image printed on a recording medium based on a printing image by an image reader, wherein the hardware processor generates a difference image based on a difference between the read image and the printing image, and determines presence or absence of a defect in the read image based on magnitude of fluctuation of a pixel value in the difference image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an outline of a mechanical configuration of an image processing apparatus according to an embodiment of the present invention;

FIG. 2 is, similarly to above, a control block diagram of the image processing apparatus;

FIG. 3 is, similarly to above, a diagram illustrating a differential image when contamination is present on an image;

FIG. 4 is, similarly to above, a diagram illustrating a differential image when contamination is present on an image and the luminance value of a RIP image is low;

FIG. 5 is, similarly to above, a diagram illustrating a differential image when a positional shift between a RIP image and a scan image has occurred;

FIG. 6 is, similarly to above, a diagram illustrating a differential image when flare has occurred on a scan image;

FIG. 7 is, similarly to above, a diagram illustrating a differential image when an error in color reproduction is present;

FIG. 8 is, similarly to above, a diagram illustrating an example of screen interference;

FIG. 9 is, similarly to above, a diagram illustrating an example of weighting coefficients of an edge detection filter;

FIG. 10 is, similarly to above, a diagram illustrating a threshold value processing result when contamination is present on a sheet;

FIG. 11 is, similarly to above, a diagram illustrating a threshold value processing result when contamination stretching in a sheet conveyance direction is present;

FIG. 12 is, similarly to above, a diagram illustrating an example of a scan image when contamination present on a sheet white area;

FIG. 13 is, similarly to above, a diagram illustrating luminance values around contamination;

FIG. 14 is, similarly to above, a diagram illustrating difference values around contamination between the scan image and the RIP image;

FIG. 15 is, similarly to above, a diagram illustrating values after an edge detection filter process; and

FIG. 16 is, similarly to above, a diagram illustrating an example of chipping on an image.

### DETAILED DESCRIPTION OF EMBODIMENTS

Hereinafter, one or more embodiments of the present invention will be described with reference to the drawings. However, the scope of the invention is not limited to the disclosed embodiments.

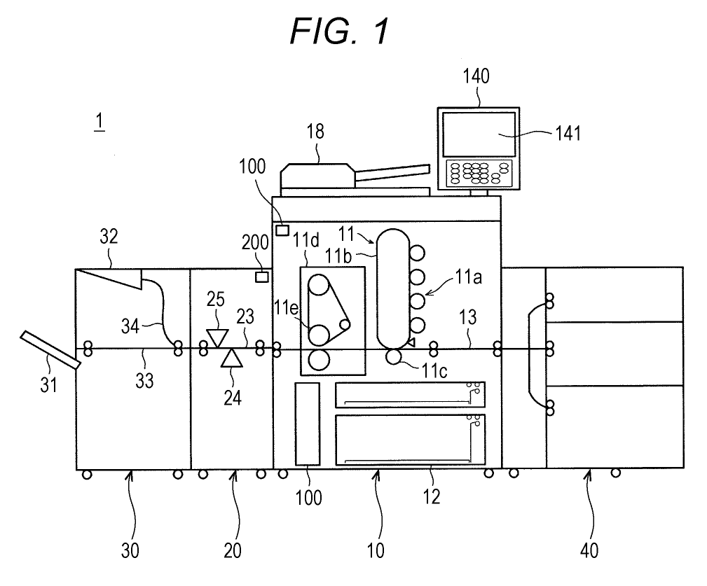

As illustrated in FIG. 1, an image forming apparatus 1 has an apparatus main body 10 that forms an image, and a sheet feeding device 40 is connected to the preceding stage of the apparatus main body 10. A reading device 20 is connected to the subsequent stage of the apparatus main body 10, and a post-processing device 30 is connected to the subsequent stage of the reading device 20. Each device and the apparatus main body are electrically and mechanically connected and communication and sheet conveyance are possible between respective devices.

In this embodiment, the image forming apparatus t is constituted by the apparatus main body 10, the sheet feeding device 40, the reading device 20, and the post-processing device 30. However, the image forming apparatus may be constituted only by the apparatus main body 10 or constituted by adding another device to the apparatus main body 10. In this embodiment, the image forming apparatus 1 includes a configuration as an information processing apparatus of the present invention.

The sheet feeding device 40 is provided with a plurality of sheet feed stages and sheets are accommodated in each sheet feed stage. The sheets accommodated in the sheet feed stages can be supplied to the apparatus main body 10 installed at the subsequent stage. The sheet corresponds to a recording medium. The material of the recording medium is not limited to paper and the recording medium may be made of cloth, plastic, or the like. A printed matter of the present invention is one obtained by outputting a recording medium after an image is formed thereon.

In the apparatus main body 10, a main body sheet feeder 12 provided with a plurality of sheet feed trays is arranged on a lower side in a casing. In the main body sheet feeder 12, sheets are accommodated in each sheet feed tray. The sheet corresponds to the recording medium of the present invention and the material thereof is not limited to paper; the recording medium may be made of cloth or plastic.

A conveyance path 13 is prepared within the casing of the apparatus main body 10 and the sheet supplied from the sheet feeding device 40 or the main body sheet feeder 12 is conveyed to a downstream side along the conveyance path 13.

An image former 11 that forms an image on the sheet is prepared near the middle of the conveyance path 13.

The image former 11 has photoconductors 11a for each color (cyan, magenta, yellow, and black) and a charger, a laser diode (LD), a developer, a cleaner, and the like (not illustrated) are provided around the photoconductors 11a. The image former 11 also has an intermediate transfer belt 11b at a position where the intermediate transfer belt 11b makes contact with the photoconductors 11a for each color. The intermediate transfer belt 11b makes contact with the sheet on the conveyance path 13 at a secondary transferor 11c prepared in the middle of the intermediate transfer belt 11b. In addition, a fixer 11d including a fixing roller 11e is provided at a position on the downstream side of the secondary transferor 11c on the conveyance path 13.

In the case of forming an image on the sheet, after the photoconductors 11a are uniformly charged by the charger, the photoconductors 11a are irradiated with a laser beam from the laser diode (LD) and latent images are formed on the photoconductors 11a. The latent images on the photoconductors 11a are developed by the developer to toner images, the toner images on the photoconductors 11a are transferred to the intermediate transfer belt 11b, and the image on the intermediate transfer belt 11b is transferred onto the sheet at the secondary transferor 11c. The image is fixed by the fixer 11d on the sheet conveyed along the conveyance path 13 after the image is formed thereon.

In this embodiment, the image former 11 has been described as forming a color image. However, in the present invention, the image former 11 may form an image in monochrome in black or the like.

Image formation on both sides of the sheet may be enabled by preparing a reverse conveyance path in front of and behind the image former 11 and performing reversal conveyance of the sheet.

Furthermore, the apparatus main body 10 is provided with an operation unit 140 on a top portion of the casing. The operation unit 140 has a liquid crystal display (LCD) 141 provided with a touch panel and a group of operation keys, such as a numeric keypad, so as to be able to display information and accept operation input. The operation unit 140 serves as both of a display and an operation unit.

In this embodiment, the operation unit 140 is constituted by integrating the operation unit and the display, but the operation unit and the display may not be integrated. For example, the operation unit may be constituted by a mouse, a tablet, a terminal, or the like. In addition, the LCD 141 may be movable.

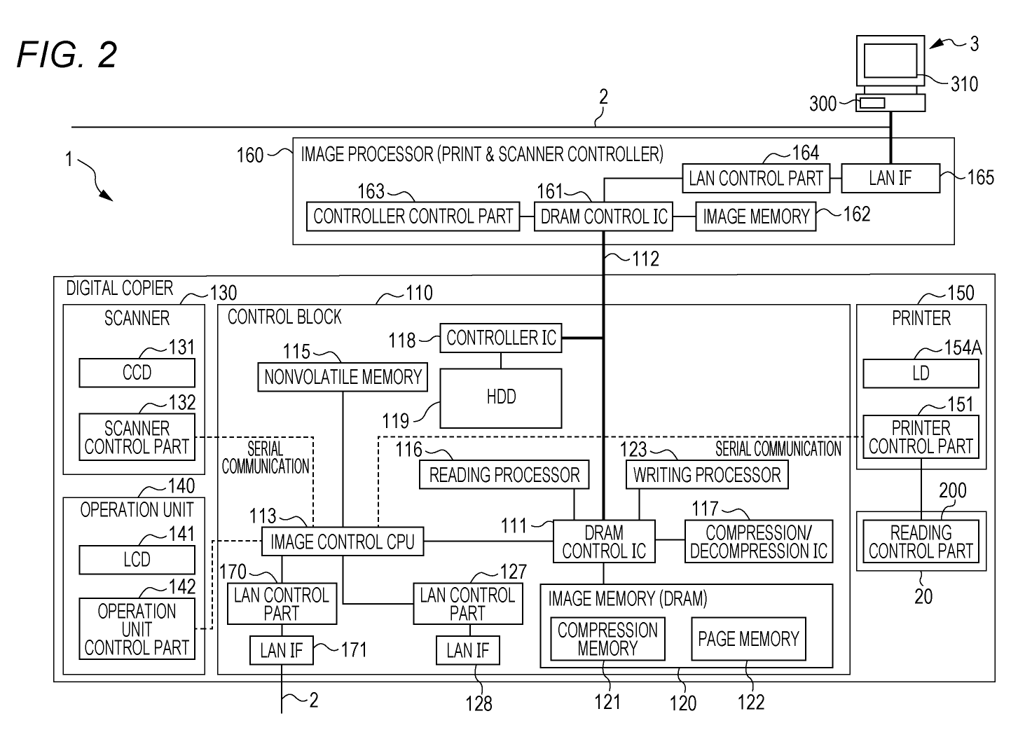

An automatic document feeder (ADF) 18 is provided on a top portion of the casing of the apparatus main body 10 at a place where the operation unit 140 is not located. The automatic document feeder (ADF) 18 automatically feeds a document set on a document table and a document fed by the automatic document feeder (ADF) 18 is read by a scanner 130 illustrated in FIG. 2.

A document on a platen glass (not illustrated) can also be read.

In the scanner 130, it is also possible to set a printed matter output from the image forming apparatus 1 to perform reading. For example, a sheet on which a printing image is formed is set and read, such that a read image can be acquired. In this case, the scanner 130 corresponds to an image reader of the present invention.

Furthermore, the apparatus main body 10 has an image control part 100. The image control part 100 controls the entire image forming apparatus 1 and is constituted by a central processing unit (CPU), a memory, and the like. Note that the image control part 100 may be prepared outside the casing of the image forming apparatus. In this embodiment, the image control part 100 includes a control part of the present invention. Programs activated by the CPU include a program executed by the control part of the present invention.

The reading device 20 has a conveyance path 23 and the sheet introduced from the apparatus main body 10 is conveyed along the conveyance path 23. The downstream side of the conveyance path 23 is connected to the post-processing device 30 at the subsequent stage.

An image reader 24 that reads an image on a lower surface of the sheet conveyed through the conveyance path 23 and an image reader 25 that reads an image on an upper surface of that sheet are provided near the middle of the conveyance path 23, where the image reader 24 is positioned on the upstream side of the image reader 25.

The image readers 24 and 25 can be constituted by a line sensor such as a charge coupled device (CCD) sensor or a complementary metal oxide semiconductor (CMOS) sensor, and are capable of reading an image of the sheet conveyed through the conveyance path 23 over the entire direction intersecting with a conveyance direction. A reading result read by the image reader 24 or the image reader 25 is provisionally sent to a reading control part 200 provided in the reading device 20 as a read image and transmitted from the reading control part 200 to the image control part 100. The image control part 100 can determine the presence or absence of a defect in an image based on a comparison between the read image and the printing image. As the printing image, image data after a RIP process, image data obtained by scanning a document, or the like can be used. The read image may be obtained by reading one side of the sheet, or may be obtained by reading both sides of the sheet.

Note that, in this embodiment, it is possible to read images of the front and back sides of the sheet by the two image readers, but the number of the image readers is not particularly limited. A single image reader may be employed and images of the front and back sides of the sheet may be read by the single image reader by preparing a reverse conveyance path in front of and behind the image reader and performing reversal conveyance of the sheet.

In this embodiment, the reading result is transmitted to the image control part 100 such that the image control part 100 determines whether there is a defect in the image, but the reading control part 200 provided in the reading device 20 may determine whether there is a defect in the image. The determination result can be transmitted to the image control part 100. When the reading control part 200 makes a determination, the reading control part 200 functions as the control part of the present invention and the reading device 20 constitutes an image inspection apparatus as an image processing apparatus.

The post-processing device 30 has a conveyance path 33 and conveys the sheet introduced front the reading device 20 to the downstream side. A post-processor (not illustrated) is provided in a central pail of the conveyance path 33. The post-processor can execute predetermined post-processes; for example, the post-processor can perform a stapling process and a punching process and moreover, can perform a post-process including folding, such as inner triple folding, saddle stitching, Z-folding, gate folding, and quarter folding. The post-processor may perform a plurality of post-processes.

Furthermore, a conveyance path 34 is branched off from the conveyance path 33 in the middle of the conveyance path 33. The conveyance path 33 is connected to a first sheet discharger 31, whereas the conveyance path 34 is connected to a second sheet discharger 32.

The sheet on which the post-process has been performed is discharged to the first sheet discharger 31, while the sheet on which the post-process has not been performed is discharged to the second sheet discharger 32. Furthermore, when it is determined that there is a defect in the image on the sheet, the sheet having a defect in the image may be discharged to a discharge destination different from the regular discharge destinations.

Furthermore, although the image forming apparatus 1 is provided with the reading device 20, the reading device 20 may be provided within the casing of the image forming apparatus; additionally, the image forming apparatus and the reading device may not be mechanically connected. The image forming apparatus 1 may have the image reader or may not have the image reader.

Next, an electrical configuration of the image forming apparatus 1 will be described with reference to FIG. 2.

The image forming apparatus 1 has a digital copier and an image processor (print & scanner controller) 160 in the apparatus main body 10 as main configurations. The digital copier has a control block 110, the scanner 130, the operation unit 140, and, a printer 150. The image processor (print & scanner controller) 160 processes image data input from and output to an external device.

The control block 110 has a peripheral component interconnect (PCI) bus 112. A dynamic random access memory (DRAM) control integrated circuit (IC) 111 in the digital copier is connected to the PCI bus 112 and an image control CPU 113 is connected to the DRAM control IC 111. A hard disk drive (HDD) 119 is also connected to the PCI bus 112 via a controller IC 118.

A nonvolatile memory 115 is connected to the image control CPU 113. Programs executed by the image control CPU 113, setting data such as machine setting information, a process control parameter, and the like are retained in the nonvolatile memory 115 and the HDD 119.

In the nonvolatile memory 115 and the HDD 119, programs and parameters for executing a procedure of working out a difference between the read image obtained by reading the printed matter and the printing image data to generate a difference image and a procedure of determining the presence or absence of a defect based on the magnitude of fluctuation of a pixel value in the difference image, an edge detection filter, a threshold value for determining contamination and the like are further retained. The nonvolatile memory 115 and the HDD 119 correspond to a storage medium.

A sheet profile is also recorded in the nonvolatile memory 115 and the HDD 119 and, in the sheet profile, information such as the sheet size and the basis weight associated with the type of sheet is recorded. Note that these programs and parameters may be retained in a portable removable storage medium.

The image control CPU 113 is capable of grasping the entire state of the image forming apparatus 1 by executing the program and controlling the entire image forming apparatus 1 and can perform control of actions such as sheet conveyance and image formation, processes on image data for image formation, and the like. In this embodiment, the image control CPU 113 and the programs activated by the image control CPU 113 constitute the image control part 100 and, in this embodiment, the image control part 100 functions as the control part of the present invention. The programs may be retained in the HDD 119 or the like as well as the nonvolatile memory 115 or may be retained in a portable storage medium.

The image control part 100 determines a defect in the image based on the read image. Details of the determination will be described later.

Additionally, a scanner control part 132 of the scanner 130 is connected to the image control CPU 113 so as to enable serial communication.

The scanner 130 is provided with a CCD 131 and the scanner control part 132. The CCD 131 can optically read an image on the sheet. The scanner control part 132 controls the entire scanner 130 and controls reading of an image by the CCD 131, and the like. The scanner control part 132 is connected to the image control CPU 113 so as to enable serial communication and is under the control of the image control CPU 113. The scantier control part 132 can be constituted by a CPU, a program that activates the CPU, and the like.

Image data read by the CCD 131 is transmitted to a reading processor 116 via the DRAM control IC 111 and a process such as predetermined correction is carried out in the reading processor 116.

The operation unit 140 is provided with the touch panel type LCD 141 and an operation unit control part 142. Various types of information can be displayed and operations can be input on the LCD 141. Operations can also be input by operation keys and the like. In the operation unit 140, it is possible to, for example, input various types of settings related to image formation, input a setting of a threshold value for image inspection, and set whether the image inspection is to be carried out.

In the operation unit 140, various types of settings can be made for the apparatus main body 10, the reading device 20, the post-processing device 30, and the like by operation input through the LCD 141 and operation keys. Based on the setting, the control part can control actions such as image formation, sheet conveyance, start of job output, image defect determination, post-processes, and the like.

The operation unit control part 142 controls the entire operation unit 140. The operation unit control part 142 is connected to the image control CPU 113 so as to enable serial communication and the operation unit control part 142 controls the operation unit 140 upon acceptance of a command from the image control CPU 113. The operation unit control part 142 can be constituted by a CPU, a program that activates the CPU, and the like.

An image memory (DRAM) 120 is connected to the DRAM control IC 111. The image memory (DRAM) 120 is constituted by a compression memory 121 and a page memory 122, in which image data acquired by the scanner 130 and image data acquired from an external device through a network 2 can be retained as job data, and image data of a job to be printed can be retained in the image memory (DRAM) 120.

The image memory (DRAM) 120 has the compression memory 121 and the page memory 122. Compressed image data is retained in the compression memory 121, while uncompressed page image data for image formation is temporarily retained in the page memory 122.

Furthermore, under the control of the DRAM control IC 111 described above, image data relating to a plurality of jobs can be saved in the image memory (DRAM) 120 and additionally, job setting information, reserved job image data, and the like can be saved therein. These pieces of data can also be retained in the HDD 119.

A compression/decompression IC 117 is connected to the DRAM control IC 111. The compression/decompression IC 117 can compress the image data and decompress the compressed image data.

A writing, processor 123 is additionally connected to the DRAM control IC 111. The writing processor 123 processes data for use in the image forming action in an LD 154A.

A local area network (LAN) control part 127 is connected to the image control CPU 113 and a LAN interface 128 is connected to the LAN control part 127. The network 2 and other networks can be connected to the LAN interface 128 and data can be received from and transmitted to an external device via the LAN interface 128.

A DRAM control IC 161 of the image processor (print & scanner controller) 160 is also connected to the PCI bus 112.

In the image processor (print & scanner controller) 160, an image memory 162 configured from a DRAM is connected to the DRAM control IC 161 and a controller control part 163 is connected to the DRAM control IC 161. A LAN control part 164 is additionally connected to the DRAM control IC 161 and a LAN interface 165 is connected to the LAN control part 164. The LAN interface 165 is connected to the network 2.

A LAN control part 170 is also connected to the image control CPU 113 and a LAN interface 171 is connected to the LAN control part 170. The LAN interface 171 is connected to the network 2.

A printer control part 151 of the printer 150 is additionally connected to the image control CPU 113. The printer control part 151 is constituted by a CPU, a storage, and the like and controls the entire printer 150 and an image forming action by the LD 154A upon acceptance of a command from the image control CPU 113. The LD 154A collectively refers to LDs for each color. In addition, the printer control part 151 can control the image former 11 and a conveyer including the conveyance path 23.

Furthermore, the reading control part 200 of the reading device 20 is controllably connected to the printer control part 151.

As described above, the reading control part 200 controls the entire reading device 20 and controls the reading of the image readers 24 and 25 in the control thereof. The reading control part 200 transmits information about the read image to the image control part 100 such that the image control part 100 can determine whether there is a defect in the image. However, as described earlier, the reading control part 200 may acquire the reading result to determine whether a defect has occurred in the image. The same determination technique as in a case where the image control part 100 makes determination can be employed.

An external device 3 and the like are connected to the network 2. In the image forming apparatus 1, it is possible to transmit and receive data to and from the external device 3 and the like through the network 2. The network 2 may be used as a wide area network (WAN), a telephone line, and the like besides a LAN and whether the network 2 is wireless or wired is not of concern.

The external device 3 has an external device control part 300 that controls the entire external device 3. The external device control part 300 can be constituted by a CPU, a program that activates the CPU, a storage, and the like. The external device 3 also has an external operation unit 310 capable of displaying information. When the external device 3 is used as a management device for managing the image former and the image reader, the external device control part 300 may acquire a printing image and a read image obtained by reading an image printed on the recording medium based on the printing image by the image reader, to generate a difference image based on a difference between the read image and the printing image, and determine the presence or absence of a defect in the read image based on the magnitude of fluctuation of a pixel value in the difference image. In this case, the external device 3 corresponds to the image processor of the present invention and the external device control part 300 corresponds to the control part of the present invention.

The external device 3 can also be used as a terminal or a device that manages the image forming apparatus 1. When the external device 3 is used as a terminal, the external device 3 is connected to the LAN interface 165 via the network 2. When the external device 3 is used as a device that manages the image forming apparatus 1, the external device 3 is connected to the LAN interface 171 via the network 2.

When managing the image forming apparatus, the external device 3 may directly control the image forming apparatus or may instruct the image forming apparatus on control contents such that the control part of the image forming apparatus exercises control according to these instruction contents.

A program activated by these forms of the external device control part 300 corresponds to the program executed by the control part. The external operation unit 310 can be used as the operation unit of the present invention.

Next, the basic action of the image forming apparatus 1 will be described.

First, a procedure of accumulating image data in the image forming apparatus 1 will be described.

When the scanner 130 reads the image of a document to generate image data, the document is put on the scanner 130 and the image of the document is optically read by the CCD 131. In this case, the scanner control part 132 that has accepted a command from the image control CPU 113 controls the action of the CCD 131.

The image read by the CCD 131 is sent to the reading processor 116 and the reading processor 116 carries out a predetermined data process. The image data on which the data process has been performed is sent out to the compression/decompression IC 117 to be compressed by a predetermined method in the compression/decompression IC 117 and retained in the compression memory 121 or the HDD 119 via the DRAM control IC 111.

The image data retained in the compression memory 121 or the HDD 119 can be managed as a job by the image control CPU 113. When image data is managed as a job, printing conditions are retained in association with the image data in the image memory (DRAM) 120 and the HDD 119.

The print image data and the printing conditions may be separately retained in different storage media as long as the both are associated with each other. The printing conditions may be set by a user through the operation unit 140 or may be automatically set depending on initial settings or an action status.

On the other hand, when the image data is acquired from the outside, for example, when the image data is acquired from the external device 3 or the like through the network 2, the image data is received via the LAN interface 165 of the image processor (print & scanner controller) 160. The received image data is retained in the image memory 162 via the LAN interface 165, the LAN control part 164, and the DRAM control IC 161.

Thereafter, the image data retained in the image memory 162 is provisionally retained in the page memory 122 via the DRAM control IC 161, the PCI bus 112, and the DRAM control IC 111.

When the image data is page description data, the image data can be transformed into a raster image by a RIP process performed on the image data, by the controller control part 163.

Print data retained in the page memory 122 is sequentially sent to the compression/decompression IC 117 via the DRAM control IC 111 to be subjected to the compression process and retained in the compression memory 121 via the DRAM control IC 111. In addition, in the case of retaining in the HDD 119, the print data is retained in the HDD 119 via the DRAM control IC 111 and the controller IC 118. These pieces of print data are managed by the image control CPU 113 in the same manner as described above. The image memory (DRAM) 120 and the HDD 119 serve as storages in which image data is saved.

When the image forming apparatus 1 is used as a copying machine, information such as printing conditions (print mode) set on the operation unit 140 is notified to the image control CPU 113 such that the image control CPU 113 creates setting information. The created setting information can be retained in a random access memory (RAM) in the image control CPU 113.

When the image forming apparatus 1 is used as a printer, the printing conditions can be set with a printer driver in the external device 3. As in the case of the image, the printing conditions set here are transferred to the external device 3, the LAN IF 165, the image memory 162, the DRAM control IC 161 (controller), the DRAM control IC 111 (main body), and the page memory 122 in this order and retained in the page memory 122.

When an image is output by the image forming apparatus 1, that is, when the image forming apparatus 1 is used as a copying machine or a printer, image data retained in the compression memory 121, the nonvolatile memory 115, the HDD 119, and the like is sent out to the compression/decompression IC 117 via the DRAM control IC 111 and the image data is decompressed. The decompressed image data is sent out to the writing processor 123 via the DRAM control IC 111 so as to be repeatedly extended for the LD 154A by the writing processor 123 in accordance with the set printing conditions and the LD 154A writes the extended image data to each photoconductor based on the image data. The images written on the photoconductors 11a thereafter undergo development, transfer, fixing, and the like and then are fixed on the sheet.

The sheet output by the apparatus main body 10 is sent to the reading device 20. When reading is set to be performed, the sheet is read by one or both of the image readers 24 and 25 and a read image is transmitted to the image control part 100.

The sheet that has been read is sent to the post-processing device 30 and post-processed or discharged without performing the post-process according to the post-process setting.

Next, an image inspection method in an image inspection apparatus of the present embodiment will be described. In the following description, “RIP data” indicates printing image data after the RIP process and “scan data” indicates read image data obtained by scanning a printed matter by the image reader. In addition, the following action content is executed under the control of the image control part 100, the reading control part 200, or the external device control part 300.

First, in order to compare the RIP data with the scan data, processes such as color conversion, resolution conversion, and alignment are performed. Although the description of color conversion, resolution conversion, and alignment techniques is omitted, one or more of these methods is used and there is no particular limitation on which one is to be adopted.

Upon completion of the above processes, a difference image is generated from the converted RIP data and scan data. The difference image is generated by calculating a difference between pixel values of each pixel (Scan-RIP). At this time, a point where there is no difference between the RIP data and the scan data may be utilized as an intermediate value (128 in the case of 256 gradations) such that a difference in a plus direction (the scan image is brighter) and a difference in a minus direction (the scan image is darker) are also distinguishable.

Thereafter, in order to detect a place (edge) where the fluctuation in value with respect to an adjacent pixel is larger in the difference image, a process of applying the edge detection filter to the difference image is performed and the edge is emphasized. Through this process, a point where the fluctuation in value between pixels is larger is emphasized. Note that pixels having a predetermined interval are selected for comparison. The interval is not particularly limited, but adjacent pixels are preferable.

As the edge detection filter, for example, a Sobel filter or a Robinson filter can be used, but the type of usable filters is not particularly limited in the present invention.

In the following description, a 3×3 filter is used to emphasize the fluctuation in value with respect to an adjacent pixel, but the size of the filter usable in the present invention is not particularly limited; a 5×5 filter may be used in order to work out a value that fluctuates between pixels away from each other by two pixels or a larger filter may be used.

After the process by the edge detection filter, a binarization process is performed using a predetermined threshold value to specify the presence or absence of an edge.

The threshold value used for the binarization process can be set according to the level of a defect the user wishes to identify.

Since the value after the edge detection filter process varies depending on the coefficient of the edge detection filter to be used, it is desirable to set the threshold value based on the type of the edge detection filter. For example, a threshold value associated with the type of filter may be saved in advance in the storage such that a threshold value according to the type of a filter to be used is used. In addition, learning can also be performed based on past inspection results such that the threshold value is adjusted.

Since the edge portion of the image has larger fluctuations in gradation, a larger difference is observed due to the positional shift, which causes erroneous identification. For this reason, it is desirable to extract edge information in advance from the RIP image and to exclude the edge region from the objects to be inspected. Note that the edge portion may not be excluded from the objects to be inspected and a different determination from the other regions may be made; for example, a different threshold value from a regular threshold value can be used in the edge portion.

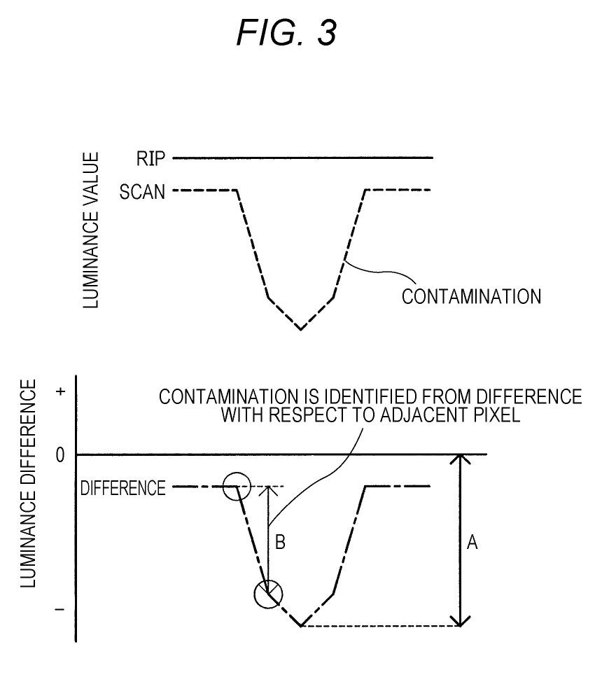

Here, FIG. 3 illustrates a differential image when there is contamination on the scan image.

If there is contamination on the scan image, as illustrated in the upper part of FIG. 3, the luminance value of the scan image locally drops due to contamination.

Therefore, the luminance value of the difference image which is the difference between the scan image and the RIP image has the same shape as the scan image as illustrated in the lower part of FIG. 3.

In a conventional inspection method, the presence or absence of contamination is determined depending on the magnitude of the difference between the two images (=the absolute value of the luminance value in the difference image) (“A” in FIG. 3); however, in the present embodiment, contamination is identified from the difference from an adjacent pixel (“B” in FIG. 3).

In the case of using the inspection method of the present embodiment, erroneous identification of contamination can be suppressed when the luminance value of the RIP image becomes darker as a whole after color change.

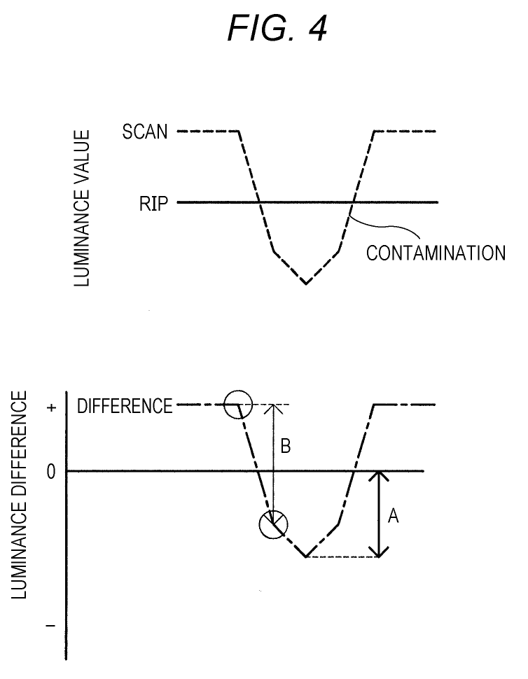

FIG. 4 illustrates a case where the luminance value of the RIP image is lower as a whole (the color is more dense).

In the difference image in this case, as illustrated in the lower part of FIG. 4, the luminance value of the difference image becomes positive in a region without contamination and the luminance value thereof becomes negative in a region with contamination.

For this reason, when the absolute value of the luminance value in the difference image is worked out (the value of “A”), the magnitude of the difference is smaller than in the case of FIG. 3 and there is a possibility that contamination is not determined in comparison with the threshold value, although contamination is really present.

On the other hand, in the inspection method of the present embodiment, since the determination is made based on the fluctuation of the luminance value with respect to the adjacent pixel (“B” in FIG. 4), the same determination as in the case of FIG. 3 is made. Consequently, contamination can be accurately identified irrespective of the color difference between the scan image and the RIP image.

In addition, even in a case where a minute positional shift that is not deemed as waste has occurred, erroneous identification of a defect can be prevented. Waste is determined to be abnormal as a defect in the image.

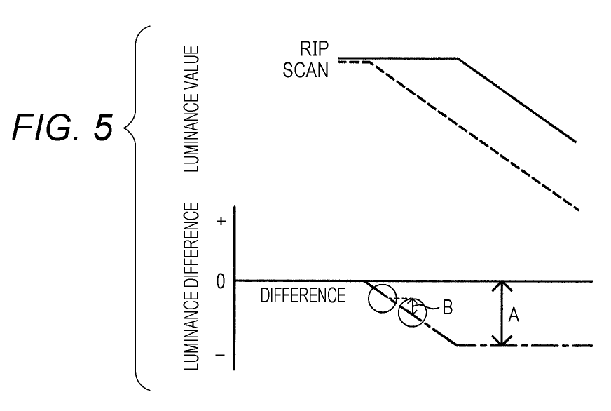

FIG. 5 is a differential image when a minute positional shift has occurred. It is supposed here that a minute positional shift has occurred when the scan image and the RIP image are aligned and it is assumed that no positional shift to be deemed as waste has occurred.

As illustrated in the upper part of FIG. 5, when a positional shift has occurred, inconsistency according to the positional shift occurs; accordingly, as the difference between the RIP image and the scan image, a difference equivalent to “gradation fluctuation of RIP×positional shift amount” is produced. On the other hand, the difference between the adjacent pixels in the difference image is produced mainly from the gradation fluctuation of the RIP image.

Therefore, there is a possibility that contamination is erroneously identified in a case where contamination is determined based on the absolute value of the difference (the value of “A” in FIG. 5); however, in a case where contamination is determined based on the fluctuation of the difference with respect to the adjacent pixel (the value of “B” in FIG. 5), since the fluctuation value is smaller, the probability of erroneous identification is lowered.

In addition, even when flare has occurred in the scan image, erroneous identification of contamination can be suppressed.

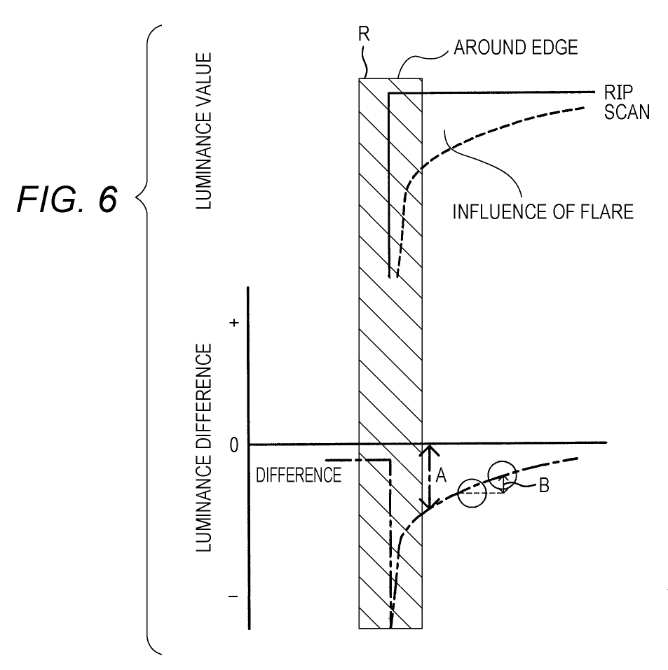

FIG. 6 is a differential image when flare has occurred on the scan image.

As illustrated in the upper part of FIG. 6, when flare occurs on the scan image due to the influence of light from the periphery, the image becomes darker as it approaches the edge due to the influence of flare. Therefore, as illustrated in the lower part of FIG. 6, the difference between the RIP image and the scan image becomes larger around the edge.

For this reason, when the determination is made by working out the magnitude of the difference (“A” in FIG. 6) as in the prior art, since the difference takes a relatively large value, there is a possibility that a defect is erroneously identified.

On the other hand, when the determination is made based on the fluctuation of the luminance value with respect to the adjacent pixel (“B” in FIG. 6) as in the present embodiment, since the fluctuation value is smaller, the probability of erroneous identification of a defect is lowered.

In a region R around the edge of the image, the fluctuation in luminance is larger and tends to cause erroneous identification; accordingly, it is desirable to except the region R from the objects to be inspected. The region R around the edge of the image can be extracted in advance based on the RIP image.

In addition, even in a case where an error in color reproduction happens, the gradation of the scan image also does not fluctuate largely while the gradation fluctuation is small (no edge is included), such that the difference from the adjacent pixel is reduced and erroneous identification is suppressed.

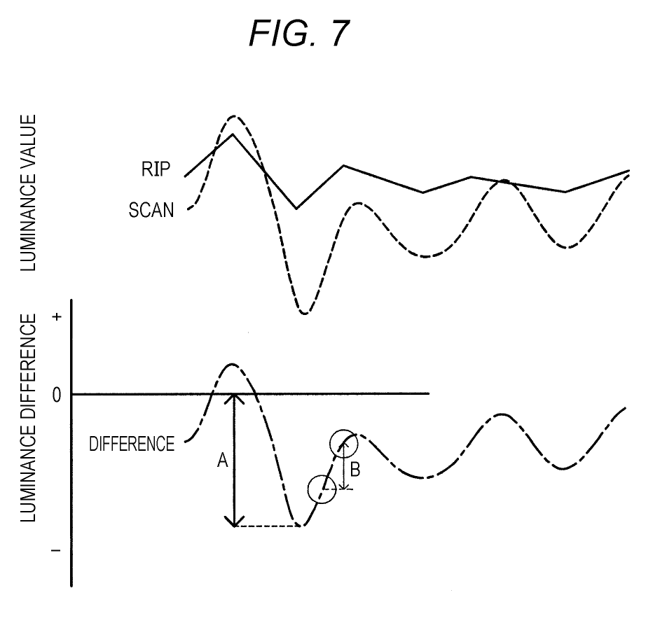

FIG. 7 illustrates a differential image when there is an error in color reproduction.

Color conversion of the RIP image or the scan image is performed before the image inspection is performed, but as illustrated in FIG. 7, there is a case where inconsistency is produced in the luminance values even if the color fluctuations can be reproduced. If there is an error in color reproduction, since the difference (“A” in the lower part of FIG. 7) takes a relatively large value in a case where a defect is determined based on the absolute value of the difference, there is a possibility that it is erroneously determined that there is a defect.

On the other hand, when a defect is determined based on the magnitude of fluctuation of the difference from the adjacent pixel (“B” in the lower part of FIG. 7) by the method of the present embodiment, since the fluctuation value of the difference is relatively small, the probability of being determined as a defect is lowered and erroneous identification of an abnormality can be suppressed.

Furthermore, according to the method of the present embodiment, erroneous identification due to screen interference can also be suppressed.

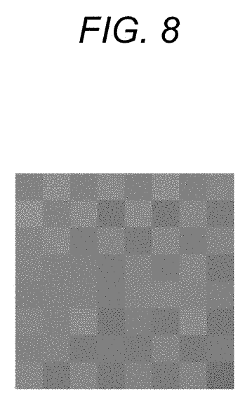

When screen interference has occurred, as illustrated in FIG. 8, a dense portion and a light portion appear alternately in units of one pixel, which causes erroneous identification of a defect.

In the present embodiment, when the edge detection filter is applied to the image in FIG. 8, similar values are given on the left and right sides and the upper and lower sides of the filter; accordingly, the screen interference is canceled out by the coefficients of the edge detection filter and the screen interference is not detected as an edge.

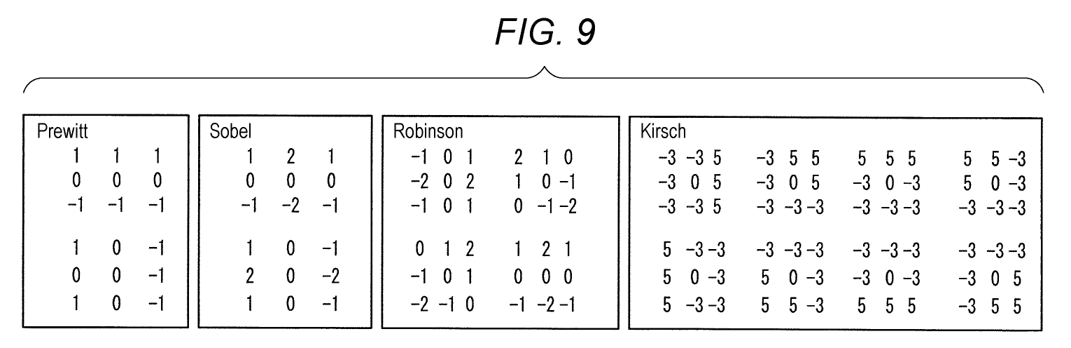

An example of weighting coefficients of the edge detection filter is illustrated in FIG. 9.

Note that the edge detection filter is not limited to the Prewitt, Sobel, Robinson, and Kirsch filters illustrated in FIG. 9 and any edge detection filter can be used. In addition, the size of the filter is not also particularly limited and a filter having a desired size can be used.

In the determination of the presence or absence of a defect, in a case where consecutive pixels exceed the threshold value, it is determined that there is a defect.

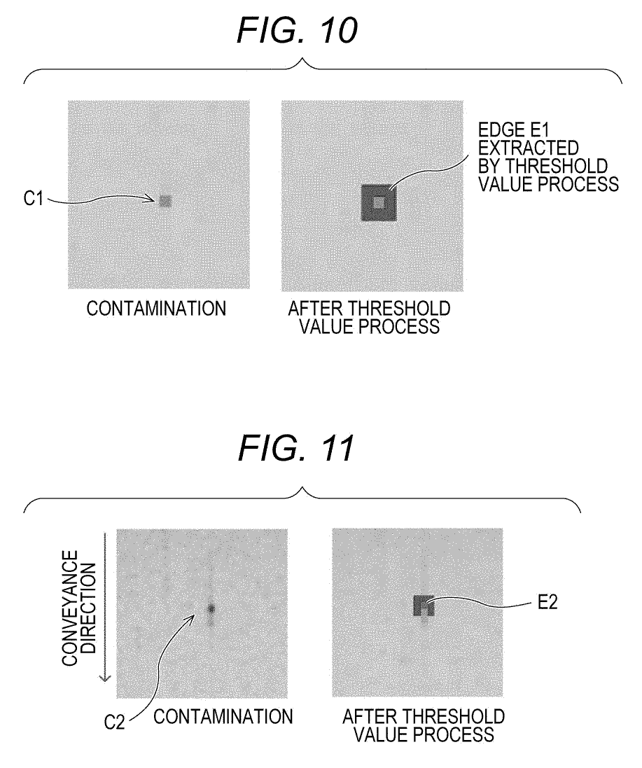

FIG. 10 is a diagram illustrating contamination C1 on the image and an edge E1 extracted by a threshold value process.

When the edge detection filter is applied to the difference image between the RIP image and the scan image and threshold value process is performed, pixels exceeding the threshold value are consecutively detected so as to surround the contamination, as illustrated in FIG. 10. Pixels having fluctuation values exceeding the threshold value are consecutively placed around the contamination; therefore, a case where the number of consecutive pixels exceeding the threshold value is equal to or greater than a predetermined number is discriminated as contamination.

The predetermined number can be set according to the size of the contamination to be detected. For example, in the case of detecting contamination of one pixel, the predetermined number is defined as eight such that it can be determined that contamination is present when consecutive eight pixels exceed the threshold value; when it is desired to selectively detect large contamination, the number of consecutive pixels can be set larger.

Furthermore, in the case of dense contamination, contamination sometimes blurs in the conveyance direction of the sheet, as illustrated in FIG. 11. For this reason, the number of consecutive pixels, which is the criterion of determination, may not be set to the size surrounding the contamination to be detected.

The left diagram of FIG. 11 illustrates contamination C2 blurring in the conveyance direction of the sheet, and the right diagram of FIG. 11 is a diagram in which the difference image of the image in the left diagram is binarized by applying the edge detection filter.

As illustrated in FIG. 11, when dense contamination blurs in the conveyance direction of the sheet, a region with low density is produced. For this reason, even if the process is performed using the edge detection filter, pixels exceeding the threshold value (edge E2) are not present so as to surround the contamination, and pixels that do not exceed the threshold value appear in the conveyance direction of the sheet. Therefore, it is desirable that the number of consecutive pixels be set to a number that does not surround contamination. For example, it may be determined that there is contamination when five pixels consecutively exceed the threshold value.

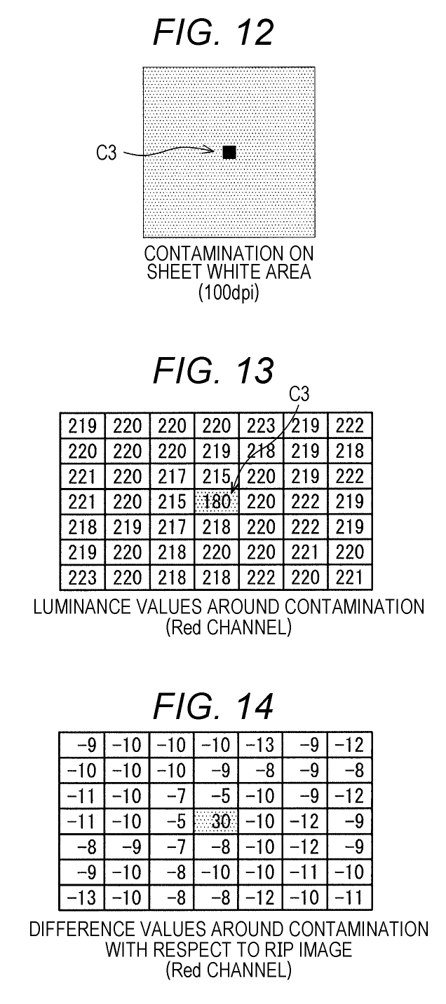

Next, a flow in a case where the image inspection method described above is actually applied will be described with reference to FIGS. 12 to 15.

As illustrated in FIG. 12, a case where contamination C3 is present on a sheet white area is illustrated as an example.

First, a sheet is read by the image readers 24 and 25 and the luminance value of each pixel is calculated in the scan image (read image).

FIG. 13 illustrates the calculation result of the luminance values of the pixels around the contamination. Here, the luminance value of the pixel where the contamination is present is 180, which is lower than the luminance values of the surrounding pixels.

Next, a difference image is generated from the difference between the scan image and the RIP image.

The luminance values of the pixels around the contamination in the difference image are illustrated in FIG. 14. Here is illustrated a case where the value of the sheet white area of a red channel when the color of the RIP data is changed to RGB is 210.

In FIG. 14, the difference value of the pixel with contamination is 30, while the difference values of the pixels around that pixel with contamination is within the range of −5 to −10; it is found therefrom that the difference of the pixel having the contamination C3 is larger

Thereafter, in order to search out a place (edge) in which the fluctuation between pixels in the difference image is larger, the binarization process is performed on the difference image after the process using the edge detection filter is performed. Here, it is assumed that a Robinson filter is used as the edge detection filter and the threshold value is 29.

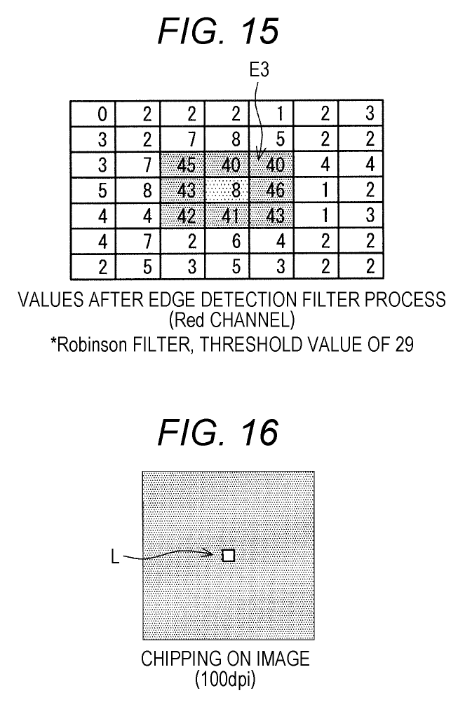

As illustrated in FIG. 15, the difference image after the edge detection filter process has 8 for the value of the pixel with contamination and 40 to 46 for the pixels around that pixel with contamination, such that the pixels having values exceeding the threshold value (an edge E3 in FIG. 15) are present so as to surround the contamination.

Since the consecutive pixels have values exceeding the threshold value, it is determined that there is a defect on the image.

In the above description, detection of contamination has mainly been described, but it is also possible to detect chipping of image by the same method.

FIG. 16 illustrates a case where chipping L is present on the scan image. When chipping happens in the image, the luminance value of a region where the image is chipped becomes higher and accordingly, if the difference between the scan image and the RIP image is calculated, the luminance value of the difference image becomes larger in the region with chipping.

Therefore, in the same manner as the contamination determination action, it is possible to detect chipping of the image by working out the fluctuation of the luminance value in the difference image and performing the threshold value process.

According to the present embodiment, it is possible to suppress erroneous identification of a defect when image inspection based on a comparison between the scan image and the RIP image of an output item is performed.

In the above embodiment, the reading device is prepared at the subsequent stage of the apparatus main body 10 and the inspection is performed using an in-line sensor in the reading device; however, reading may be performed by an external scanner or the like without using the reading device 20 such that the inspection is performed offline.

Although embodiments of the present invention have been described and illustrated in detail, the disclosed embodiments are made for purposes of illustration and example only and not limitation and any modifications can be made to the above embodiments as appropriate without departing from the scope of the present invention. The scope of the present invention should be interpreted by terms of the appended claims.

What is claimed is:

1. An image processing apparatus comprising a hardware processor that acquires a read image obtained by reading an image printed on a recording medium based on a printing image by an image reader, wherein
the hardware processor generates a difference image based on a difference between the read image and the printing image, and determines presence or absence of a defect in the read image based on magnitude of fluctuation of a pixel value in the difference image.

2. The image processing apparatus according to claim 1, wherein the hardware processor determines presence or absence of the defect based on fluctuation of pixel values between pixels at a predetermined interval in the difference image.

3. The image processing apparatus according to claim 1, wherein the hardware processor determines presence or absence of the defect based on fluctuation of pixel values between adjacent pixels in the difference image.

4. The image processing apparatus according to claim 1, wherein the hardware processor calculates magnitude of the fluctuation by performing a process using an edge detection filter on the difference image.

5. The image processing apparatus according to claim 1, wherein the hardware processor detects the defect in the read image by comparing magnitude of the fluctuation with a threshold value.

6. The image processing apparatus according to claim 5, wherein the hardware processor is capable of modifying the threshold value.

7. The image processing apparatus according to claim 5, wherein the hardware processor designates the threshold value based on a type of an edge detection filter to be used.

8. The image processing apparatus according to claim 5, wherein the hardware processor determines that there is a defect in the read image when a predetermined number or more of pixels consecutively have magnitude of fluctuation exceeding the threshold value in the difference image.

9. The image processing apparatus according to claim 5, wherein the hardware processor determines that there is no defect in the read image when a predetermined number or more of pixels do not consecutively have magnitude of fluctuation exceeding the threshold value in the difference image.

10. The image processing apparatus according to claim 1, wherein the hardware processor extracts a portion of an edge from the printing image and modifies a method of the determination between the extracted portion of the edge and a portion other than the edge.

11. The image processing apparatus according to claim 10, wherein the hardware processor excludes the portion of the edge from objects for the determination.

12. The image processing apparatus according to claim 1, wherein, in determining presence or absence of the defect, the hardware processor determines presence or absence of at least one of contamination and chipping.

13. The image processing apparatus according to claim 1, wherein the printing image is a raster image processor image.

14. The image processing apparatus according to claim 1, further comprising an image former that forms an image on a recording medium.

15. The image processing apparatus according to claim 1, further comprising an image reader that reads an image on a recording medium.

16. The image processing apparatus according to claim 1, wherein the hardware processor manages an image forming apparatus and the image reader.

17. A non-transitory recording medium storing a computer readable program executed by a hardware processor that acquires a printing image and a read image obtained by reading an image printed, on a recording medium based on the printing image by an image reader,
the computer readable program causing the hardware processor to execute:
acquiring the printing image;
acquiring a read image read by the image reader;
generating a difference image based on a difference between the printing image and the read image; and
determining presence or absence of a defect in the read image based on magnitude of fluctuation of a pixel value in the difference image.
